(19) United States
(12) Patent Application Publication
(10) Pub. No.: US 2009/0208639 A1
(43) Pub. Date: Aug. 20, 2009

(54) METHOD OF FORMING VANADIUM TRIOXIDE THIN FILM SHOWING ABRUPT METAL-INSULATOR TRANSITION

(75) Inventors: Sun-Jin Yun, Daejeon-city (KR); Byung-Gyu Chae, Daejeon-city (KR); Hyun-Tak Kim, Daejeon-city (KR); JungWook Lim, Daejeon-city (KR); Bong-Jun Kim, Daejeon-city (KR)

Correspondence Address: RABIN & Berdo, PC, 1101 14TH STREET, NW, SUITE 500, WASHINGTON, DC, 20005, US

(73) Assignee: Electonics and Telecommunications Research Institute, Daejeon-city (KR)

(21) Appl. No.: 12/307,573

(22) PCT Filed: Jun. 29, 2007
(86) PCT No.: PCT/KR2007/003173

§ 371 Date: Jan. 5, 2009

(30) Foreign Application Priority Data
Jul. 6, 2006 (KR) 1020060063473
Dec. 8, 2006 (KR) 1020060125064

(51) Int. Cl. B05D 5/12

(52) U.S. Cl. 427/126.3

(57) ABSTRACT

Provided is a method of manufacturing a V₂O₃ thin film having an abrupt MIT characteristic. The method forms a thin film of one of VO₂ and V₃O₇ on a substrate. Then the substrate on which thin film is formed is mounted in a chamber in which a reduction atmosphere capable of removing oxygen is formed, and annealed to form a V₂O₃ thin film having an abrupt MIT.

### TECHNICAL FIELD

The present invention relates to a method of manufacturing a thin film having an abrupt metal-insulator transition (MIT) characteristic, and more particularly, to a method of manufacturing a V₂O₃ thin film having an abrupt MIT characteristic.

### BACKGROUND ART

V₂O₃ shows antiferromagnetic insulator characteristics at a MIT temperature or lower, and shows metal characteristics at a MIT temperature or higher. In order to apply a V₂O₃ thin film to electronic devices such as switches or sensors, a thin film having an abrupt MIT characteristic needs to be manufactured.

V₂O₃ is one of vanadium oxides which can be changed between various states according to the chemical binding state of vanadium to oxygen, wherein examples of the vanadium oxides are V₂O₅, VO₂, and V₃O₇. One of these intermediate states of vanadium oxide is represented as VOₓ. Like VO₂, which undergoes a phase transition from an insulator to a metal at 67° C., V₂O₃ undergoes a phase transition at around −113 -−103° C. (by B. McWhan et al., Phys. Rev. B 7, p 1920, 1973). However, a very slow or indistinct MIT has been reported in the case of a thin film although V₂O₃ in bulk undergoes an abrupt MIT.

FIG. 1 is a graph showing the specific resistance of V₂O₃ according to temperature suggested by S. Yonezawa et al. in Solid State Communications 129, p. 245, 2004. Here, the V₂O₃ thin film is manufactured using a pulsed laser deposition (PLD) method. Although PLD is known to be one of the best deposition techniques for crystalline thin films, the films fabricated in Yonezawa's work did not show an abrupt MIT.

Referring to FIG. 1, V₂O₃ (b) in bulk shows an abrupt MIT at around 180 K. However, V₂O₃ in a form of a thin film, for example, V₂O₃ (a) on a sapphire (Al₂O₃) substrate or V₂O₃ (c) on a LiTaO₃ substrate, does not show an abrupt MIT. That is, V₂O₃ in a thin film shows a slow resistance change between 80-180 K, i.e. a slow MIT. Thus a V₂O₃ thin film showing an abrupt MIT has not yet been reported. Here, the abrupt MIT is very important because the abrupt MIT is one of evidences insisting the hole-driven MIT. The hole driven MIT theory explains that, in the first place, MIT takes place by injecting holes, then phase transition is secondarily induced by the joule heating due to the increased current. The abrupt MIT is also vey important characteristic to be utilized in a highly sensitive switches or sensors.

Vanadium oxide exists in various states, as described above. However, except VO₂ and V₂O₃, which respectively undergo a phase transition near 67° C, (340 K)and −113° C. (160 K), there is no phase transition reported at a temperature of 67° C. or lower. In the case of the resistance changing slowly over a wide temperature region as illustrated in FIG. 1, it has been inferred that the thin film is not a single V₂O₃ phase and several different phases of vanadium oxides and/or the intermediate states (VOₓ(0.5<×<1.5)) coexist.

### DISCLOSURE OF INVENTION

### TECHNICAL PROBLEM

The present invention provides a method of manufacturing a V₂O₃ thin film showing an abrupt MIT characteristic near 160K.

### TECHNICAL SOLUTION

According to an aspect of the present invention, there is provided a method of manufacturing a V₂O₃ thin film having an abrupt MIT characteristic, the method comprising: forming one thin film selected from VO₂ and V₃O₇ on a substrate; placing the substrate on which the thin film is formed into a chamber containing a reduction atmosphere for removing oxygen; and heating the chamber to form a V₂O₃thin film having an abrupt MIT characteristic.

According to another aspect of the present invention, there is provided a method of manufacturing a V₂O₃ thin film having an abrupt MIT characteristic, the method comprising: forming one thin film selected from VO₂ and V₃O₇ on a substrate; placing the substrate on which the thin film is formed into a chamber containing a reduction atmosphere for removing oxygen; and heating the chamber to form a V₂O₃ thin film having an abrupt MIT characteristic. In addition, (V₁₋ₓAₓ)₂O₃ is formed in the V₂O₃ thin film by employing an element A which can control the transition characteristics.

### DESCRIPTION OF DRAWINGS

The above and other features and advantages of the present invention will become more apparent by describing in detail exemplary embodiments thereof with reference to the attached drawings in which:

FIG. 1 is a graph showing the specific resistance change of V₂O₃ according to temperature, suggested by S. Yonezawa et al. in Solid State Communications 129, p 245, 2004;

FIGS. 2A through 2C are cross-sectional views illustrating a process of manufacturing a V₂O₃ thin film according to an embodiment of the present invention;

FIG. 3 is a schematic view of a sample structure used in the measurement of resistance change of a V₂O₃ thin film according to the temperature. The film was manufactured according to an embodiment of the present invention; This structure is only for a measurement of resistance change with respect to temperature.

FIG. 4A is a graph showing the resistance change of the V₂O₃ thin film according to the temperature. The film was fabricated using a sol gel method according to an embodiment of the present invention;

FIG. 4B is a graph showing the resistance change of the V₂O₃ thin film according to the temperature. The V₂O₃ thin film was fabricated using an atomic deposition method according to an embodiment of the present invention;

FIG. 5A is a schematic view illustrating the definition of the resistance variations (ΔR) used in the present invention; and

FIG. 5B is a graph showing Δ R of the V₂O₃ thin film according to the annealing temperature, for selecting the appropriate annealing temperature in a reduction atmosphere.

### BEST MODE

The present invention will now be described more fully with reference to the accompanying drawings, in which exemplary embodiments of the invention are shown. The invention may, however, be embodied in many different forms, and should not be construed as being limited to the embodiments set forth herein; rather, these embodiments are provided so that this disclosure will be thorough and complete, and will fully convey the concept of the invention to those skilled in the art. Like reference numerals denote like elements throughout the specification.

The embodiments of the present invention provide a method of manufacturing a V₂O₃ thin film having an abrupt MIT from an insulator (or semiconductor) in a monoclinic structure to a metal having a rhombohedral structure at a temperature much lower than a room temperature, near 160K.

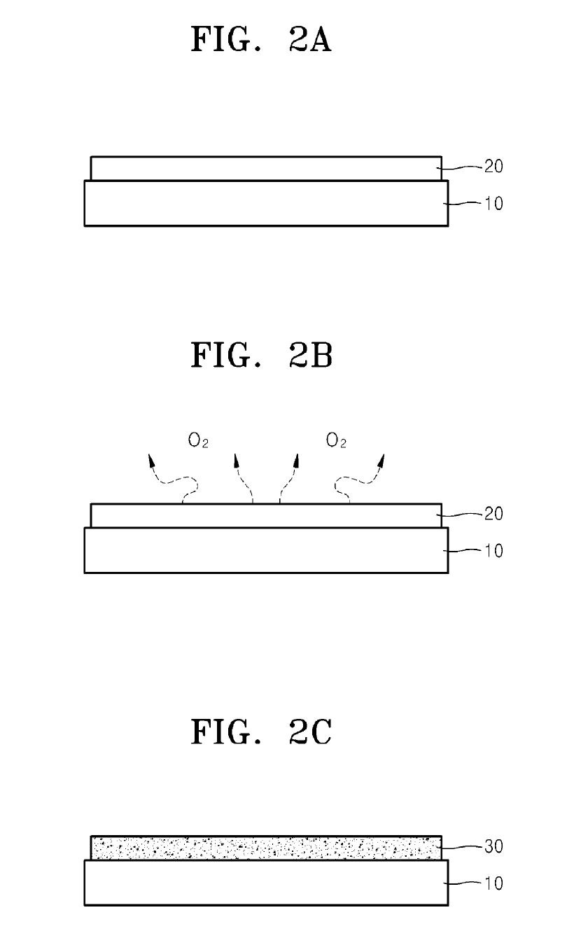

FIGS. 2A through 2C are cross-sectional views illustrating a process of manufacturing a V₂O₃ thin film according to an embodiment of the present invention.

Referring to FIG. 2A, a VO₂ or V₃O₇ thin film 20 is formed as a starting material on a substrate 10 of sapphire, silicon (Si), glass, quartz, or magnesium oxide (MgO). In the current embodiment, a VO₂ thin film is used as the starting material. The VO₂ thin film may be manufactured using a chemical deposition method, an atomic layer deposition method, a plasma atomic layer deposition method, a sputtering deposition method, a sol gel method, etc. Selectively, the VO₂ thin film may be formed by manufacturing a V₂O₅ thin film reduced at an appropriate oxygen partial pressure.

Referring to FIG. 2B, the VO₂ thin film is heated in a reduction atmosphere to remove oxygen. Specifically, the VO₂ thin film is heated in a chamber under a vacuum or while applying inert gas such as nitrogen, argon, etc. in a vacuum atmosphere, or while applying a reduction gas such as hydrogen in a vacuum atmosphere. The temperature at which oxygen is most actively removed from the VO₂ thin film is 350-400° C., and thus the heat treatment temperature and the temperature of the chamber should be 400° C. or higher. Here, nitrogen, argon, hydrogen, or a mixture of these is injected. The pressure of the chamber in the current embodiment using vacuum environment was 1×10⁻² torr or lower.

Referring to FIG. 2C, a V₂O₃ thin film according to an embodiment of the present invention is formed on the substrate 10. In other words, when oxygen is removed from the VO₂ thin film, a V₂O₃ thin film according to the present invention is manufactured. Meanwhile, if the starting material is V₃O₇ , the V₃O₇ thin film can be also formed using various thin film manufacturing methods as in the case of the above described VO₂ thin film.

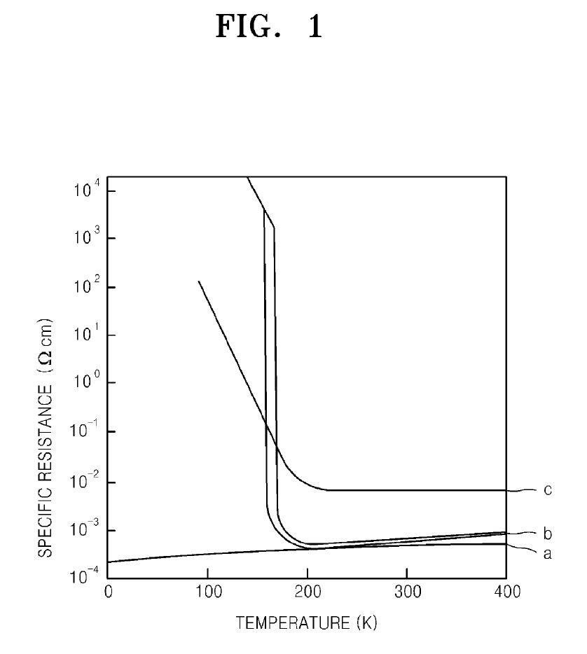

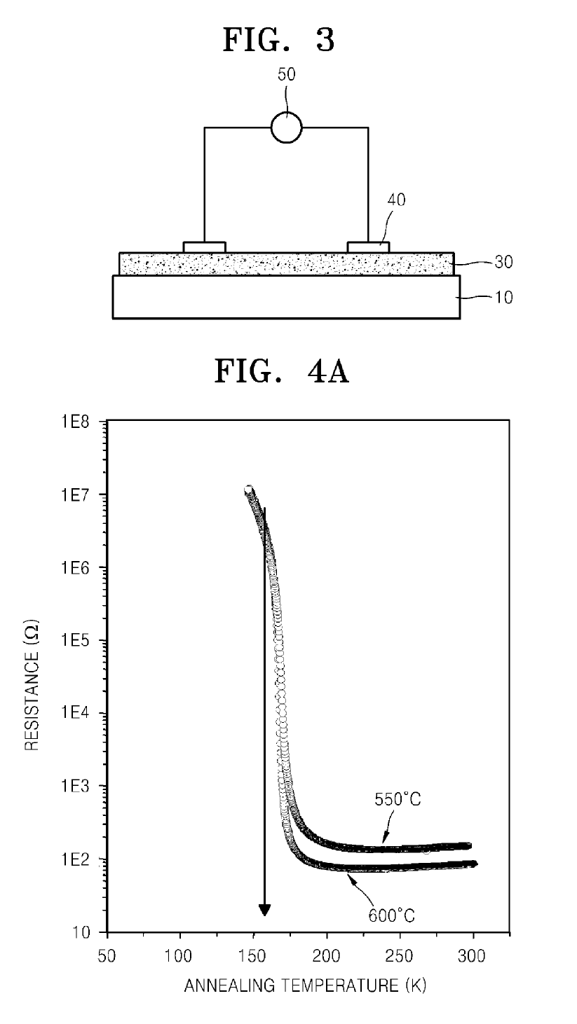

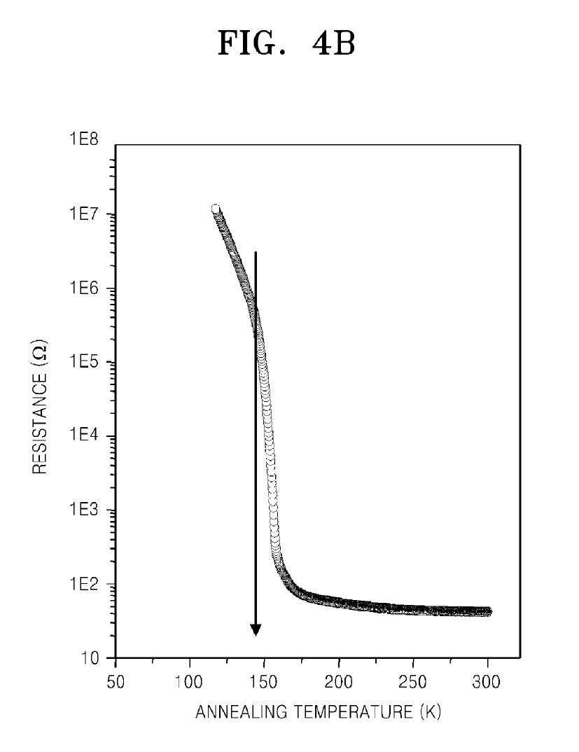

FIG. 3 is a schematic view of a measurement system for measuring resistance according to the temperature of a V₂O₃ thin film manufactured according to the present invention. FIG. 4A is a graph showing the resistance according to the temperature of V₂O₃ thin film fabricated using a sol gel method. FIG. 4B is a graph showing the resistance according to the temperature of V₂O₃ thin film fabricated using an atomic deposition method. Here, the V₂O₃ thin film is manufactured according to the method described with reference to FIGS. 2A through 2C. Referring to FIGS. 3 and 4A, resistance with respect to temperature is measured by a resistance measurement device 50 connected to an electrode 40 that is patterned on a V₂O₃ thin film. As illustrated, the V₂O₃ thin film shows an abrupt resistance decrease near 160-170 K. The abrupt decrease in resistance is not shown by the conventional V₂O₃ thin film which is deposited by a PLD method as illustrated in FIG. 1. On the other hand, the V₂O₃ thin film manufactured according to the method of the present invention shows an abrupt MIT. Also, as illustrated, when the heat treatment temperature is changed, the resistance in the metal state is changed. For example, the V₂O₃ thin film heated at 600 ° C. has a lower resistance than the V₂O₃ thin film heated at 550° C.

Referring to FIGS. 3 and 4B, the V₂O₃ thin film shows an abrupt resistance decrease near 145 K, as in FIG. 4A. The difference is merely that the resistance is abruptly decreased near 145 K, which is lower by approximately 15 K than in FIG. 4A. This difference seems to be due to differences in the properties of the V₂O₃ thin film, and such small changes in the transition temperature of VO₂ due to defects or impurities have been reported in the case of VO₂, which is a well known MIT material. In the case of V₂O₃, the abrupt MIT temperature seems to be in the range of 140-180K. According to hole-driven MIT theory, the MIT temperature is defined to generate holes more than the critical hole concentration. Therefore, the temperature range as wide as 40K can be explained using the inhomogeniety of materials in the film although the major component of the film is V₂O₃. However, it should be noticed that 40K is the difference in MIT temperature and not indicating a slow transition shown in earlier reports.

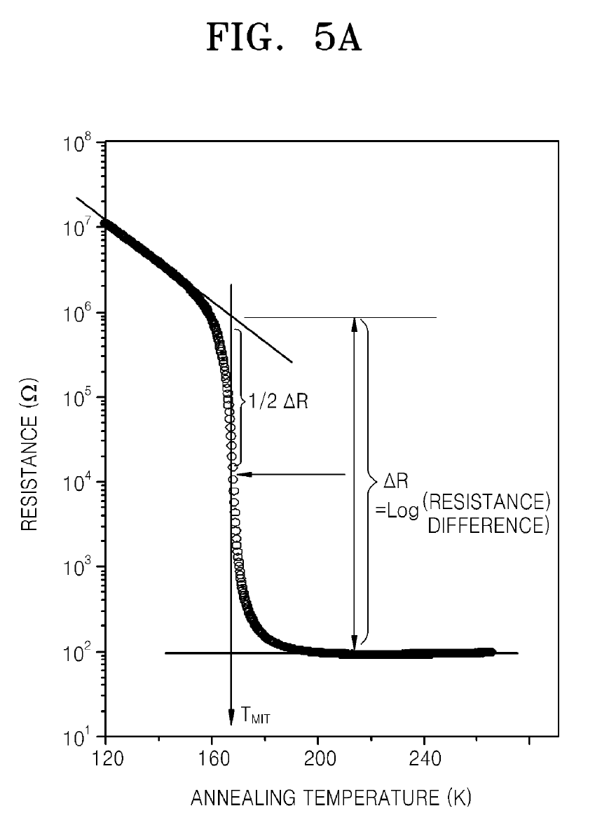

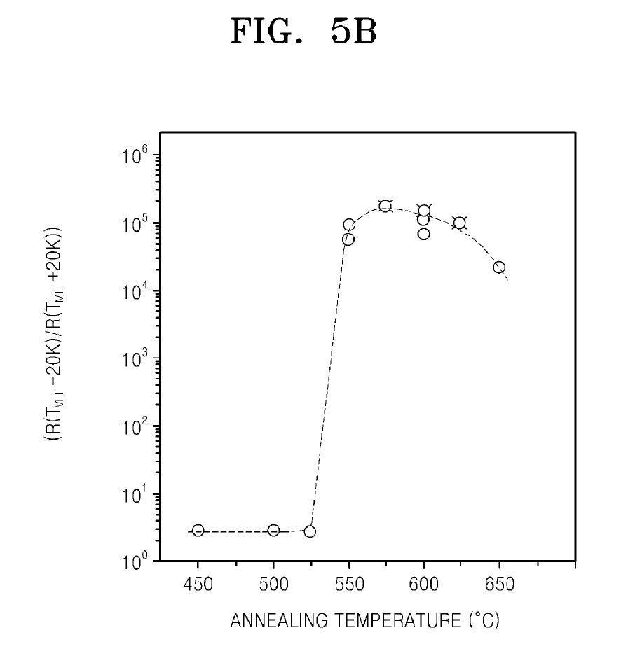

FIG. 5A is a curve showing the resistance change according to the temperature of a typical V₂O₃ thin film obtained according to the present invention. As illustrated in FIG. 5A, after obtaining a resistance change curve using a log scale, ΔR is defined as illustrated in FIG. 5A, and as denoted with an arrow, a temperature at which a resistance corresponding to half of ΔR is defined as T_{MIT}. FIG. 5B is a graph showing resistance change with respect to the annealing temperature, to select the range of the appropriate annealing temperature. The horizontal axis denotes the annealing temperature and the vertical axis denotes (R(T_{MIT}−20 K)/R(T_{MIT}+20 K)) which is the value of the resistance at a temperature of (T_{MIT}−20 K) divided by the resistance at a temperature of (T_{MIT}+20 K).

Referring to FIGS. 5A and 5B, the precursor films (VO₂ or V₃O₇) are heated at a temperature higher than 500° C. in order to make V₂O₃ showing an MIT behavior. However, if the heat treatment temperature is too high, for example, 650° C. or higher, a slight decrease is observed. However, the V₂O₃ thin film can be applied to a substantial device even when the resistance change (R(T_{MIT}−20 K)/R(T_{MIT}+20 K)) is lower than 10⁻⁴. Meanwhile, when the V₂O₃ thin film is annealed for more than 30 minutes, in general, the V₂O₃ thin film will show the same or a little better transition characteristics as the V₂O₃ thin film annealed for 30 minutes. Also, the appropriate annealing time can be varied according to the form of the V₂O₃ thin film to be annealed.

Accordingly, in consideration of the annealing time and the form of the sample, the annealing temperature to make the V₂O₃ thin film that can be applied to a substantial device may be 500-1000° C., preferably 530-650° C. In order to use a short annealing time, the appropriate annealing temperature should be increased. For example, if you want to use annealing time as short as a few minutes—a few ten seconds, the annealing temperature should be higher than 700° C. If you want to use annealing time as short as a few seconds, the annealing temperature should be much higher than 800° C. Also, the ratio of resistance (R(T_{MIT}−20 K)/R(T_{MIT}+20 K)) for figuring the MIT characteristic is 10-10⁷, and preferably 10³-10⁷. The thickness of the films used in these exemplary embodiments is approximately 70 nm. When you use thicker film, you can see the larger value of (R(T_{MIT}−20 K)/R(T_{MIT}+20 K)), probably 10⁷ as shown in bulk V₂O₃.

Also, the present invention can be applied to a (V₁₋ₓAₓ)₂O₃ (A: additive) thin film which controls the transition temperature to be higher or lower by adding impurities artificially. In the case of V₂O₃ in bulk, it is reported in a previously published article about the material having a composition of (V₁₋ₓAₓ)₂O₃ by adding a metal A, that the transition temperature is changed according to the type and amount of the additive.

Thus the present invention can be applied to V₂O₃ which generates a phase transition not only at the standard temperature of 140-180 K, but also at a lower or a higher temperature and also to other thin films including other elements.

The present invention also suggests an in-situ annealing process in a deposition chamber when a VO₂ or V₃O₇ thin film is deposited in a vacuum chamber by atomic layer deposition, chemical deposition, sputtering deposition, etc., instead of exposing the specimen.

As described above, according to the method of manufacturing a V₂O₃ thin film, a VO₂ or V₃O₇ thin film is annealed in a reduction atmosphere to fabricate a V₂O₃ thin film, thereby manufacturing a V₂O₃ thin film having an abrupt MIT characteristic.

While the present invention has been particularly shown and described with reference to exemplary embodiments thereof, it will be understood by those of ordinary skill in the art that various changes in form and detail may be made therein without departing from the spirit and scope of the present invention as defined by the following claims.

1. A method of manufacturing a V₂O₃ thin film having an abrupt MIT, the method comprising:
forming one thin film selected from VO₂ and V₃O₇ on a substrate;
placing the substrate on which the thin film is formed into a chamber of a reduction atmosphere for removing oxygen; and
annealing the thin film to form a V₂O₃ thin film showing an abrupt MIT.

2. The method of claim 1, wherein the VO₂ is manufactured using V₂O₅.

3. The method of claim 1, wherein the reduction atmosphere is formed using a vacuum.

4. The method of claim 3, wherein the pressure of the vacuum state is 1 □10² torr or lower.

5. The method of claim 1, wherein the reduction atmosphere is formed using at least one of nitrogen gas (N₂), argon gas (Ar), and hydrogen gas (H₂) .

6. The method of claim 5, wherein the reduction atmosphere is formed in a vacuum of 1 □10² torr or lower and using at least one of nitrogen gas (N₂), argon gas (Ar), and hydrogen gas (H₂)

7. The method of claim 1, wherein the annealing temperature of the thin film for forming V₂O₃ film is 500-1000° C.

8. The method of claim 7, wherein the temperature is in the range of 530-650° C.

9. The method of claim 1, wherein the resistance ratio of the insulator to the metal (R(T_{MIT}−20 K)/R(T_{MIT}+20 K)) is 10 to 10⁷.

10. The method of claim 9, wherein the ratio of resistance is 10³ to 10⁷.

11. The method of claim 1, wherein the transition temperature is 140-180 K.

12. The method of claim 1, further comprising forming (V₁₋ₓAₓ)₂O₃ in the V₂O₃ thin film by employing an element A which can control the transition characteristics.
